(19) United States
(12) Patent Application Publication
(10) Pub. No.: US 2018/0300577 A1
(43) Pub. Date: Oct. 18, 2018

(54) THEMED APPLICATION FOR PRESENTING OPTIONS TO PURCHASE CONTENT ASSOCIATED WITH THE THEME ON A PORTABLE ELECTRONIC DEVICE

(71) Applicant: Rok Mobile International Ltd., Culver City, CA (US)

(72) Inventor: Jonathan Kendrick, Culver City, CA (US)

(21) Appl. No.: 15/953,279

(22) Filed: Apr. 13, 2018

Related U.S. Application Data
(60) Provisional application No. 62/485,823, filed on Apr. 14, 2017.

(51) Int. Cl. G06K 9/32; G06F 17/30; G06T 1/00

(52) U.S. Cl. CPC G06K 9/3241; G06F 17/30047; G06Q 2220/18; G06T 2207/30196; G06T 1/0007

(57) ABSTRACT

A method performed by a programmed processor in a portable electronic device that is executing an artist-centric application program stored in the device. The method analyses an object captured in an image to detect a structural pattern and compares the structural pattern with several predefined structural patterns to identify a matching predefined structural pattern, where each predefined structural pattern is associated with a piece of specially licensed content of an artist. Upon identifying a matching predefined structural pattern, the method presents, on a display screen of the portable electronic device, a notification with an option to purchase a particular piece of specially licensed content of the artist that is associated with the matching predefined structural pattern. Other embodiments are also described and claimed.

This patent application claims the benefit of the earlier filing date of U.S. provisional patent application No. 62/485,823 entitled, “An artist centric application for a portable electronic device” and filed Apr. 14, 2017.

### FIELD

An embodiment of the invention relates to an artist-centric application running on a portable electronic device that presents a user with an option to purchase content of an artist associated with the application. Other embodiments are also described.

### BACKGROUND

With the proliferation of portable devices (e.g., smartphones) that are capable of connecting to the Internet, users of those devices have an endless selection of audio-visual works that can be delivered to their devices. Although some content may be free, the majority of licensed content must be purchased through an on-line vendor. Once purchased, the user may enjoy viewing or hearing the licensed content through the portable device in which the content was purchased.

### SUMMARY

An embodiment of the invention is an artist-centric application that runs on a portable electronic device (e.g., smartphone, tablet) that is capable of presenting a user of the portable device an option to purchase audio-visual content (e.g., music or any other type of audio-visual work) of an artist associated with the application, through pattern recognition. The artist-centric application, which may be provided free to the user, can be downloaded from a server (of a service provider) over the Internet and installed into the portable electronic device. Once the application is launched in the portable device, the user may “aim” the devices built-in digital camera at an object that the user recognizes as being associated with the artist, e.g., a picture or resemblance of the artist or poetry or song lyrics or a saying by the artist, as shown on a page of a book, on a poster, on a billboard, or on a television or video monitor. The camera will then capture an image of the object, and in response, and automatically (without further user input required), the application then analyzes the captured image to recognize patterns therein (e.g., structural patterns.) This may be done by comparing portions of the captured image to patterns that have been previously stored in the device (as part of the downloaded app), in order to find a matching predefined structural pattern. If one is matched then a recognition event is said to occur, in response to which the application may then present the user (by showing a prompt on a touchscreen of the device) with an option to purchase specially licensed audio-visual content that is associated with the matching pattern (or recognition event.) The specially licensed audio-visual content may be, for example, audio-visual content depicting the artist, or artist's work, which has been exclusively licensed (by the artist) to the provider of the application.

Since the application is performing the pattern recognition locally or within the portable device, any delay associated with accessing an image pattern recognizer that might otherwise be running on a remote server in the Internet is avoided. Moreover, any delay associated with accessing a decision maker that might otherwise be running on the remote server, which makes a decision as to which special audio-visual content should be presented for this particular instance of the recognition event, is also avoided, thereby making the presentation to the user, of the option to purchase the specially licensed content, essentially immediately after the user has aimed the device at the object.

In one embodiment, the artist-centric application allows a user who purchases a book that has content, e.g., pictures, drawings, poetry, lyrics, and sayings, by the artist (the book may be published by the same provider of the application), to enjoy more content relating to the artist. The images and text in the pages of the book have been previously analyzed by an image/text pattern recognizer, to define predefined structural patterns for the content within the book, and the predefined structural patterns have been associated with options to purchase more content relating to the artist. This data may then be incorporated within the application, so that when the user's portable device captures an image of a piece of content within the book, the application may immediately present the user with an option to purchase more related content. To illustrate, assume the book includes a page that shows a picture of the artist performing on stage at a concert in Rome. Upon analysis of the page, the provider had generated a predefined structural pattern for the picture and incorporated it (with an option to purchase more related content) into the application. If the user of the book wishes to see more about the picture of the artist performing in Rome, the user may simply aim the camera of the portable device at the page that has that picture. The application receives a captured image of the page and can then match the stored predefined structural pattern with a structural pattern in the captured image, and in response presents the user with the option associated with the matching pattern, to purchase specially licensed content relating to the artist's performance in Rome (e.g., a backstage video clip of the artist preparing to go on stage).

Another embodiment of the invention is an application that runs on a portable electronic device (e.g., smartphone, tablet) that is capable of presenting a user of the portable device an option to purchase content (e.g., any type of audio-visual content, such as music, movies, or games) that relates to a theme (e.g., a person, company, place, or group of things) associated with the application, through the use of digital pattern recognition. The application, which may be provided free to the user, can be downloaded from a server (of a service provider) over the Internet and installed into the portable electronic device. Once the application is launched in the portable device, the user may “aim” the devices built-in digital camera at an object that the user recognizes as being associated with the theme. For example, if a theme of an application is a particular music artist (an individual or a group of individuals). The object may be something associated with that particular artist, e.g., a picture or resemblance of a member of a band, or poetry or song lyrics or a saying by a member of the band, as shown on a page of a book, on a poster, on a billboard, or on a television or video monitor. The camera captures an image of the object, and in response, automatically (without further user input required), the application then analyzes the captured image to recognize patterns therein (e.g., structural patterns.) This may be done by comparing portions of the captured image to patterns that have been previously stored in the device (as part of the downloaded app), in order to find a matching predefined structural pattern. If one is matched, then a recognition event is said to occur, in response to which the application may then present the user (by showing a prompt on a touchscreen of the device) with an option to purchase content that is associated with the matching pattern (or recognition event.) The content may be, for example, specially licensed audio-visual content depicting the particular artist, or the particular artists work, which has been exclusively licensed to the provider of the application.

In one embodiment, rather than being associated with an artist, the application may be associated with a location, such as an amusement park, or more specifically, an amusement park ride within the park. Once the application is launched in the portable device, while the device is located within the location, the user may aim the device at an object, e.g., a poster, a character, or a statute. The camera will then capture an image of the object, and similar to the previously described artist-centric application, the “location-centric” application analyzes the captured image to recognize patterns therein. If a recognition event occurs, the location-centric application may then present the user with an option to purchase audio-visual content associated with the matching pattern. For example, while waiting in a queue to enter the ride in the amusement park, the user may capture an image of a poster. In response to a recognition event, the location-centric application may present the user with an option to purchase content, such as a “behind the scenes” video, or a game, which are both related to the particular ride.

In one embodiment, when the application is associated with a company, (a “company-centric” application), the application may not only recognize structural patterns of objects captured by the built-in camera of the device, which are related to the company, but also those that are related to competitors of that company or products sold by the competitor. For example, the object may be anything associated with a competitor, such as a picture of a logo, an advertisement, or a product sold on the competitor's website or within the competitor's store. If a recognition event occurs (e.g., based on an analysis of a captured image of the object to recognize patterns therein), the application may present the user with audio-visual content (e.g., a commercial or promotion) that is associated with the company. In the event that the object includes a product sold by the competitor, the application may present the user with an option to purchase that product or a similar product sold by the company. Thereby, providing the user with an option to purchase the product from the company at a more competitive price.

In one embodiment, the application allows a user who purchases a book that has content, e.g., pictures, drawings, poetry, lyrics, and sayings, related to the theme of the application (the book may be published by the same provider of the application), to enjoy more content relating to the theme. For example, with respect to the artist-centric application, the book may include content relating to the artist. In one embodiment, the book may include content of a general theme, e.g., movies, music, and television programs, to name a few. The images and text in the pages of the book have been previously analyzed by an image/text pattern recognizer, to define predefined structural patterns for the content within the book, and the predefined structural patterns have been associated with options to purchase more content relating to the theme. This data may then be incorporated within the application, so that when the user's portable device captures an image of a piece of content within the book, the application may immediately present the user with an option to purchase more related content. To illustrate, assume the book is related to an artist and it includes a page that shows a picture of the artist performing on stage at a concert in Rome. Upon analysis of the page, the provider had generated a predefined structural pattern for the picture and incorporated it (with an option to purchase more related content) into an artist-centric application associated with the artist. If the user of the book wishes to see more about the picture of the artist performing in Rome, the user may simply aim the camera of the portable device at the page that has that picture. The application receives a captured image of the page and can then match the stored predefined structural pattern with a structural pattern in the captured image, and in response presents the user with the option associated with the matching pattern, to purchase specially licensed content relating to the artist's performance in Rome (e.g., a backstage video clip of the artist preparing to go on stage).

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, in the interest of conciseness and reducing the total number of figures, a given figure may be used to illustrate the features of more than one embodiment of the invention, and not all elements in the figure may be required for a given embodiment.

FIG. 1 is a block diagram of one embodiment of a system that retrieves content of an artist in response to a user purchasing the content, when a pattern-recognition event occurs on a portable device in which a structural pattern of an image captured by the portable device is matched with a predefined structural pattern.

FIG. 2 is a flowchart of one embodiment of a process of presenting a user with an option to purchase specially licensed content when a pattern-recognition event occurs.

FIG. 3 is a block diagram of a portable electronic device.

### DETAILED DESCRIPTION

Several embodiments of the invention with reference to the appended drawings are now explained. Whenever the shapes, relative positions and other aspects of the parts described in the embodiments are not explicitly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

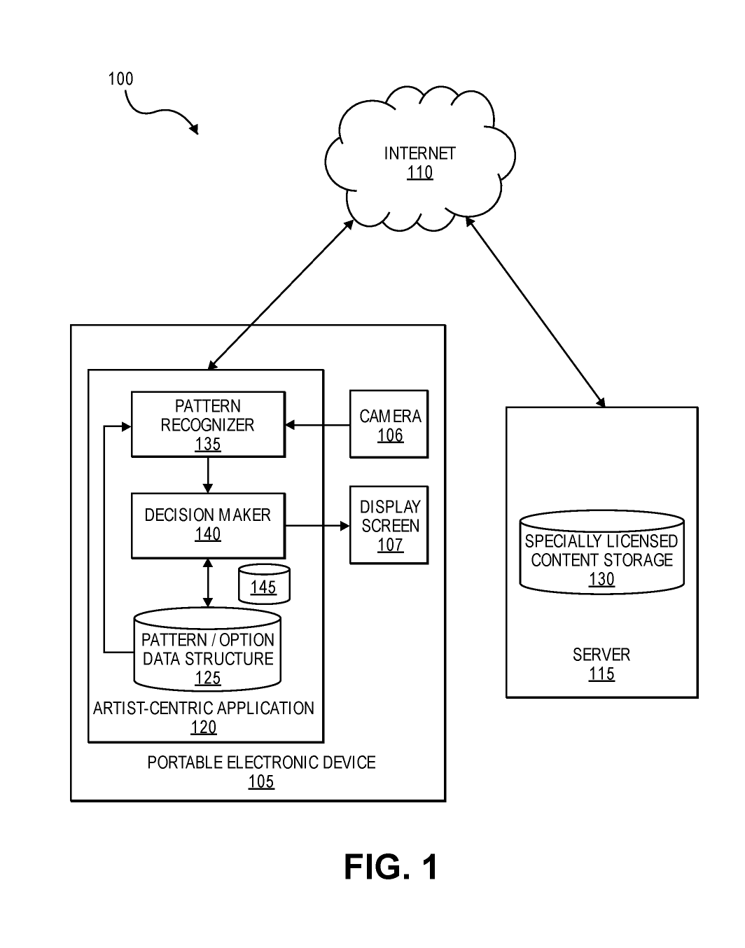

FIG. 1 is a block diagram of one embodiment of a system 100 that retrieves specially licensed content of an artist in response to a user purchasing the specially licensed content, when a pattern-recognition event occurs on a portable device in which a structural pattern of an image captured by a built-in camera of the portable device is matched with a predefined structural pattern. The system 100 includes a portable electronic device 105, the Internet 110, and a server 115. This figure may also be used to illustrate a system that retrieves other content relating to a theme, in response to a user purchasing the content, when a pattern-recognition event occurs on a portable device in which a structural pattern of an image captured by a built-in camera of the portable device is matched with a predefined structural pattern.

The portable device 105 may be any sort of electronic device that is capable of storing and executing an application (e.g., software program), capturing an image using a built-in digital camera, and connecting (wirelessly) to a server over the Internet (e.g., a tablet computer, smartphone, or any other type of portable device). The portable device 105 includes a digital camera 106, a display screen 107 (e.g., touchscreen), and an artist-centric application 120 that is stored in memory of the device 105 and that, in one embodiment, is related to a single artist (e.g., an author, an actor, a musician, a comedian, a singer, or a group of several such persons acting under a common name e.g., a musical bad or actors in a television show series). In another embodiment, the application 120 may be related to multiple artists, e.g., of a particular genre. In yet another embodiment, the application is related to a single theme, such as a person (e.g., an author, an actor, a musician, a comedian, a singer, or a group of several such persons acting under a common name e.g., a musical band or actors in a television show series), a company (e.g., a retailer), or a place (e.g., an amusement park.)

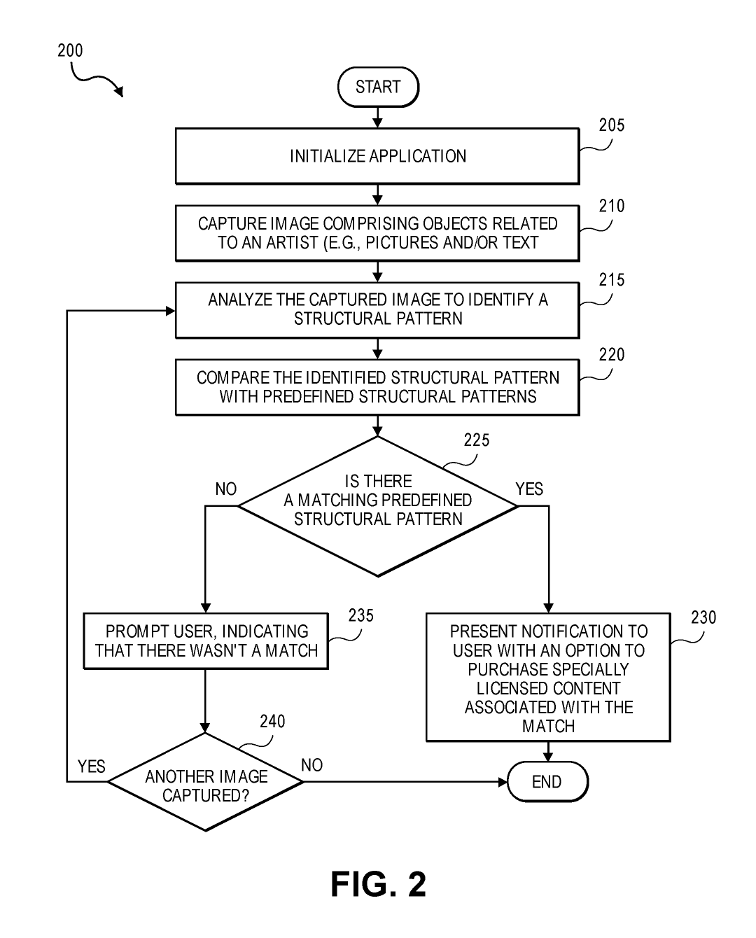

The artist-centric application 120 is for presenting the user of the device with an option to purchase specially licensed content associated with the artist of the artist-centric application in response to detecting a pattern-recognition event. For example, the user may aim the built-in camera at an “object” that the user recognizes as being associated with the artist to which the application is directed (e.g., a picture or resemblance of the artist, or text written or about the artist), as shown on for example a page of a book. The camera may capture an image of the object, and the pattern-recognition event may then occur in response to a structural pattern of the image (or a portion of the image) captured by the camera matching a predefined structural pattern. In response to the pattern-recognition event occurring, the application may present the user with the option to purchase specially licensed content associated with the predefined structural pattern that matched the pattern of the image. In other words, the specially licensed content may be associated with the object captured within the image. In this way, for example, if the object is a picture of the artist performing a concert on stage in Rome, the specially licensed content for purchase may relate to the artist's performance in Rome (e.g., a backstage video clip of the artist preparing to go on stage). In one embodiment, an option may be specific to a single predefined structural pattern, while in another embodiment the option may be a general option that is associated with several predefined structural patterns. More about the pattern-recognition event is described in FIG. 2.

The artist-centric application 120 includes a pattern recognizer 135, a decision maker 140, and a data structure 125 in which predefined structural patterns and their associated options for purchasing related specially licensed content and are arranged, for example as a lookup table (for storage in memory), and an optional content storage 145 in which content related to the options within the data structure 125 may be stored. Each of the associated options within the data structure 125 may include a description of the option (e.g., a thumbnail image and text) for display e.g., on the display screen 107, in response to the option being presented to the user. For example, the description may describe the specially licensed content related to the option. In one embodiment, the option may include a short introductory video (e.g., advertisement) relating to the content that is to be displayed on the display screen 107, prior to display of the option to purchase the content. In one embodiment, the data structure 125 may include additional descriptive information about the licensed content that is not otherwise presented to the user, but used to determine whether the option should be presented (e.g., key words relating to the content). The options may also include a code, which identifies the licensed content of the option, and is transmitted to a third-party provider for retrieving the content, when the user requests to purchase the content through the option. In the same way, the code may be used by the decision maker 140 to retrieve the content from the optional content storage 145, when it is stored locally. More about purchases the option is further described in FIG. 2.

The pattern recognizer 135, which is executing pattern-recognition software, is for determining whether a pattern-recognition event occurs. For instance, the pattern recognizer 135 may receive the digital image of the object captured by the camera 106 of the portable device 105 and processes the digital image to identify a structural pattern within the image. The pattern recognizer 135 may retrieve predefined structural patterns from the data structure 125 to determine whether a predefined pattern matches the identified structural pattern. If a match is found, the pattern recognizer may transmit data to the decision maker 140, indicating that a pattern recognition event has occurred for the matching predefined pattern.

The decision maker 140 is for deciding, when a pattern recognition event occurs, which option that is associated with the matching predefined pattern from the data structure 125 should be presented to the user on the display screen 107 of the portable device 105. In one embodiment, each predefined pattern is assigned a single option, while in another embodiment a predefined pattern may be assigned several options. In yet another embodiment, there may be multiple, different options that are associated with a single structural pattern. The decision maker 140 may then retrieve data from the data structure 125 that describes licensed content of the artist (in the option associated with the matching predefined pattern). For example, the data may indicate that one of the licensed content is not intended for young children (e.g., has a Motion Picture Association of America (MPAA) rating of “R”). The data may also describe the content through keywords (e.g., “Concert”, “Rome”). The decision maker 140 may then decide which option should be presented to the user based on the descriptions in the option field and according to several portable device criteria, e.g., user settings (parental controls) and purchase history (e.g., types of previous content purchased, and already purchased content). For example, for an artist-centric application, if the user has purchased several licensed pieces of content relating to the artist being in Rome, the decision maker 140 may decide to present the option with the content having “Rome” in its description. Once an appropriate option for a licensed piece of content is chosen, the decision maker 140 retrieves the option from the data structure 125 and transmits the option to the display screen 107 of the portable device to present the option to purchase the licensed content to the user.

The licensed content described in the presented option may be specially licensed authorized content by the artist, licensed to a provider of the application. For example, when the themed application is associated with an artist (e.g., an artist centric application) the content may be specially licensed content by the artist to the provider of the application. The specially licensed content may be musical compositions (e.g., songs) performed by or relating to the artist. The specially licensed content may also include any other type of audio-visual work relating to or of the artist (e.g., a movie in which the artist acted in, and a music video). The specially licensed content may also be content that is not readily available through media outlets or other service providers. In other words, the specially licensed content, which may be licensed and/or authorized for by the artist for distribution, may not be “mainstream content” like songs that are played on the radio or music videos that are played on television (or streamed over the Internet). Instead, the specially licensed content may be less well-known works and/or “behind the scenes” content. For example, the less well-known works may be unpublished works (e.g., songs) that had not previously been licensed and/or authorized by the artist for distribution to the public-at-large for purchase.

In one embodiment, the content is not “specially” licensed, but rather may be any type of “mainstream” licensed and/or authorized content that a provider of a themed application has been given access to. For example, when the themed application is associated with an artist, the content may include digital (or physical) albums/songs released by the artist, or merchandise or memorabilia associated with the artist (e.g., T-shirt). When the application is associated with a company the content may include products sold at the company's website and/or at the company's physical stores. In the case in which the content are tangible products (e.g., cloths, tools, and electronics), once a user purchases the products (e.g., through a selection of an option to purchase the products), the user may receive a confirm (via electronic mail) of a receipt, including the mailing address in which the product will be mailed. In one embodiment, once the user purchases the product, the user may be prompted to enter a mailing address.

To obtain the application, the user of the device 105 may download the application 120 from a (e.g., third-party) service provider for free. Once downloaded, the application 120 may be installed into memory of the device 105 and the user of the device 105 may register, through the application, with the service provider using information that is specific to the user (e.g., providing a user email address and a street mailing address). In one embodiment, the user may provide payment information (e.g., a credit card number) to the service provider, which will use this information to retrieve payment, once the user purchases the content through the application (e.g., by selecting a presented option). While in another embodiment, the user may link an account with a third-party provider payment service to the application when it is downloaded. In this way, once the user selects an option to purchase content, the service provider may receive payment from the payment service.

As previously described, certain predefined structural patterns within data structure 125 may correspond to particular objects found within publications (e.g., books, booklets, and pamphlets) that are purchased by the user. Examples of publications may include: a book about a music artist (or artists) that includes pictures or resemblances of the artist and text, such as poetry, lyrics and articles written by or relating to the artist, and a book about audio-visual works (e.g., such as a movie, genre of movies, or a television series) that includes pictures and text relating to the work). Any publication that is published by the service provider (and subsequently purchased by the user) may be analyzed by the service provider to generate the predefined structural patterns. For instance, “Page 1” of a book about an artist may have a particular predefined structural pattern, while a picture (e.g., of the artist) within Page 1 may have a different predefined structural pattern. In this way, one predefined structural pattern of an object may be made up of a combination of several other predefined structural patterns of other objects. For example, an article written in the publication may have a predefined structural pattern, while a picture and text accompanying the article may have their own predefined structural patterns. The service provider may then take each of the predefined structural patterns and associate them with the content, specifically related to the structural pattern of a portion of the book. For example, continuing with the previous example, if the picture of the artist on Page 1 is of the artist backstage at the concert in Rome, the service provider may associate the predefined structural pattern of that picture with an option to purchase exclusive specially licensed video of the artist backstage at that concert. In this way, if the user (e.g., owner) of the book wishes to see more content relating to a particular object or portion of a page within the book, the owner can just simply take a picture of that object (or portion) and be presented with an option to purchase specially licensed content associated with that object or portion of the page in the book. In one embodiment, the owner is free to transfer the book to another person (e.g., friend or relative), since the book has been purchased, rather than leased by the owner. In one embodiment, the predefined structural patterns may also correspond to other images and/or text related to the artist that is not included within any publication. For example, a predefined structural pattern may be of a “likeness” of the artist, which may allow a user of the application to purchase specially licensed content when the user takes a “live” picture of the artist (e.g., while the artist is on stage performing).

The server 115 may be a server of the service provider, in which the application 105 was downloaded. In one embodiment, the server 115 may be of any service provider that distributes (e.g., sells or licenses) the licensed content in which the user of the portable device 105 purchases. In the server 115, is a storage of licensed content 130 associated with the theme of the application (e.g., a particular person or an association of persons, an organization, a place or a thing.) In one embodiment, once the service provider has confirmed (e.g., received payment) the purchase of the licensed content by the user at the portable device 105, the server 115 may retrieve the purchased content from the storage 130 and forward the content (through the Internet 110) to the portable device 105, for presentation by the—application 120. In one embodiment, if the content is tangible (e.g., an electronic product sold by a company), the server 115 may instead transmit a sales confirmation to a distributor, in order for the distributor to mail the product to a mailing address of the user. In one embodiment, rather than retrieving the licensed content from the server 115, the content may already be stored within an optional content storage 145 within the application 120. In one embodiment, the content stored within the content storage 145 may be encrypted. In this case, once the user has purchased the content (e.g., through a selection of the option), the application 120 may transmit a confirmation of the purchase to the server 115. Once received, the server 115 may transmit a decryption key to the application 120, through the Internet 110. The application 120 may access the content through the use of the received decryption key.

In one embodiment, the application 120, along with the data stored within data structure 125 and/or the content storage 145 may be periodically updated by the service provider. This may be due to the fact that licensed content relating to the artist is continuously being created and/or updated. Once new (or different) specially licensed content is available, the service provider may then associate an option to purchase the content with previously predefined structural patterns and/or new predefined structural patterns, which may be of new images of the artist, next text written by or of the artist, or other images and/or text of the artist already in a published book (such as the book that the user has already purchased). In other embodiments, when the application 120 is associated with a company (rather than an artist), the new predefined structural patterns may be of images of new products sold by the company and/or competitors. In both instances, the service provider may then transmit the data through the Internet 110, and to the portable device 105 in order to update the data structure 125. In one embodiment, this process may be automatic and without user intervention.

FIG. 2 is a flowchart of one embodiment of a process 200 to present a user with an option to purchase specially licensed content relating to an artist when a pattern-recognition event occurs in an artist-centric application, associated with the artist. The process 200 may also be used to described where a user is presented with an option to purchase content relating to a theme (e.g., a person, organization, place, or thing) associated with the application. The process 200 will be described by reference to FIG. 1. For example, the process 200 may be performed by the artist-centric application 120 that is running on the portable electronic device 105. It should be understood that process 200 may be performed once a user of the portable device 105 has downloaded, installed, and registered (with a service provider of the application) the artist-centric application 120. As previously described, the application 120 may be a free application that the user of the portable device 105 may retrieve from the service provider. In one embodiment, the user may download the application 120, in connection with purchasing a book relating to the artist. For example, once the user purchases the book, the book may include a passage that prompts the user to download an application (e.g., 120) that is related to the artist in which the book is about. In one embodiment, the book may be a physical book, or it may be an electronic book in any electronic format (e.g., PDF). More generally, the user may purchase a book relating to a particular theme (e.g., a music artist or a genre of movies), where the book may include a passage that prompts the user to download the theme application (e.g., application 120.)). In one embodiment, the electronic book may be less expensive to purchase than the physical book. In one embodiment, the user may download the application without previously purchasing the book.

In FIG. 2, process 200 begins by initiating (at block 205) the artist-centric application (e.g., 120) by launching (or opening) the application (e.g., through a tap gesture on a graphical user interface (GUI) item displayed on the display screen 107 of the portable device 105). This initiation may be the first time in which the user opens the application (after it is downloaded and installed). In which case, the user may be required to register with the service provider, as previously described. In one embodiment, however, the initiation may be any time after the user has registered with the service provider. With the application 120 open, the process 200 captures (at block 210) an image of objects related to the artist associated with the artist-centric application. For example, as previously described, the user may have purchased a book that has a similar theme to that of the application 120 (e.g., both related to an artist or genre of movies) and with the book open to a particular page, the user may “aim” the device's built-in digital camera at a particular page (or object within the page) and have the camera capture an image (e.g., picture) of the page or object. For instance, in the case in which the book relates to an artist (and the application 120 is artist-centric) the image may be a picture of a portion of the page, such as a picture or resemblance of the artist or poetry or song lyrics or a saying by the artist, as shown on the page of the book. Or, rather than being an image of a portion of the page, the image may be of the entire page itself In one embodiment, an image may be captured of something other than an object within the book. For example, the object may be a poster, a picture on any medium (e.g., on a display screen, on a billboard, or on a t-shirt), a product for sale, or a product that the user already owns (e.g., a piece of memorabilia). It should be understood that any captured image may be of any object (on any medium) relating to the theme of the application. In the case of an artist-centric them, the image may be of the artist on stage performing in a concert, the artist in a motion picture (or any type of audio-visual work), or an image and/or text of the artist not contained within the book (e.g., on a poster, on a billboard, or on a television or video monitor). It should be understood that the captured image may include anything relating to the artist in that case.

The process 200 analyzes (at block 215) the captured image to identify a structural pattern in at least a portion of the image. This analysis may be performed by the pattern recognizer 135 which may analyze shapes within the image and their dimensions (with respect to each shape and one another) to identify structural patterns. For instance, if the image is of a person's face, the pattern recognizer 135 may identify a structural pattern relating to the persons facial structural (e.g., eyes, nose, and mouth). Along with identifying particular patterns in a person's face, the pattern recognizer 135 may also recognize patterns in pictures, signs, posters, advertisements, just to name a few. If the image is not of a person of the artist, the pattern recognizer 135 may identify particular patterns relating to the artist. For instance, the pattern recognizer 135 may identify a structural pattern in a trademarked logo of the artist (e.g., if the image includes such logo). The process 200 compares (at block 220) the identified structural pattern with the predefined structural patterns stored within the data structure 125. The process 200 determines (at block 225) whether there is a pattern recognition event, in which predefined structural pattern in the data structure 125 matches with the identified structural pattern. For instance, the pattern recognizer 135 may consider a “match” based on a percentage in which a predefined structural pattern is similar in structure to that of the identified structural pattern. For example, a match may be a predefined structural pattern that is 90% (or above) similar to that of the identified structural pattern. If there is pattern-recognition event, the process 200 presents (at block 230) the user with a prompt (e.g., a pop-up) displayed on the display screen 107 of the portable device of an option to purchase a specially licensed content associated with the matching predefined structural pattern. As previously described, this may be performed by the decision maker 140 that decides which option should be presented to the user based on data describing the predefined structural pattern and according to user settings (or purchase history) of the portable device 105. The presented option may include a description (e.g., text and a thumbnail image) of the specially licensed content and a price (e.g., $0.99) to purchase (e.g., license) the specially licensed content. Before presenting the option, a short (e.g., thirty second) introductory video (or advertisement) may be played back to the user on the display screen 107 of the portable device. In other words, the user is presented with content and/or products relating to the image captured, thereby allowing the user to selectively choose which objects or portions (e.g., within a page of the purchased book) the user wishes to receive as content. If the user wishes to purchase the specially licensed content, the user may simply select (e.g., through a tap gesture) on the option to perform an “in-app” purchase of the specially licensed content. Once selected, the portable device 105 may send a request (with a code identifying the specially licensed content from the storage structure 125,and a confirmation of the purchase) to the server 115. This may include sending a message that request an account of the user to be charged in an amount indicated in the option field (for the particular specially licensed content.) In one embodiment, once selected, the application may automatically perform the in-app purchase through a third party provider payment service, which may then transmit confirmation of the purchase to the server 115. Once the server receives confirmation of the purchase and the code, it retrieves the content from the storage 130 and forwards the content to the portable device 105. The portable device 105 then stores the content within the application 120 (e.g., within the storage structure 125) and presents the content to the user. In one embodiment, rather than retrieving content from the server 115, the application 115 may retrieve a decryption key and access encrypted content already stored within a content storage 145 within the application 120. In one embodiment, the application presents the content by displaying the video of the content in the display screen 107 and outputting audio through built-in speakers of the portable device 105. If, however, the option is to purchase a product (e.g., clothes, tools, or electronics), once the server receives confirmation of the purchase, the server 115 may transmit a sales confirmation to a distributor of the product, along with a mailing address of the user, in order for the distributor to mail the product to the user. In one embodiment, rather than automatically performing the in-app purchase, the device 105 may navigate to a graphical user interface screen for purchasing the specially licensed content. In one embodiment, the application 120 may navigate to a website owned by the service provider to complete the purchase process, in response to receiving a request by the user (e.g., a selection of the pop-up) to purchase the content.

If, however, there is no pattern-recognition event, the process 200 prompts (at block 235) the user with a notification (e.g., pop-up), indicating that there was not a match. Such a notification may simply say “No Content Found.” While, in another embodiment, when there is not a match, the notification may present the user with an option to purchase other specially content. For example, the application may present the user with an option to purchase “commonly purchased” content relating to the theme of the application 120. In one embodiment, the application may present specially licensed content in which the application believes the user may want (based on previous purchases). In one embodiment, the decision of what option should be presented to the user when a pattern-recognition event does not occur, is made by the decision maker 140. The process 200 determines (at block 240) whether another image has been taken. If another image has been taken, the process 200 proceeds back to block 215, otherwise, the process 200 ends.

The following examples of illustrations of different themed applications that present users with options to purchase different content when recognition events occur in response to capturing images of objects relating to the theme of the application. As previously described, an application associated with an artist (e.g., an artist-centric application) may present a user with an option to purchase (e.g., specially licensed) content relating to the artist. For example, with the application 120 open, the user may capture an image of an object associated with the artist (e.g., a picture or resemblance of the artist, or text written or about the artist, or a trademarked logo of the artist) with a built-in camera 106 of the portable device. Upon the occurrence of a recognition event (e.g., matching a predefined structural pattern with a structural pattern of the image), the application may present the user with an option to purchase specially licensed content related to the captured image. In some instances, the user may be prompted with an option to purchase more “mainstream” content relating or produced by the artist, based on the matching predefined structural pattern. To be presented with more mainstream content, the user may capture an image of products or memorabilia previously (or currently) relating to the artist, such as an old Long Play (“LP”) record produced by the artist. In response to the application matching a structural pattern of the image with a predefined structural pattern, the user may be presented with an option to purchase content relating to the LP record (e.g., song(s) contained within the LP record). In this way, in order to purchase digital copies of songs, a user may simply capture an image of a physical record or album, and be presented an option to purchase the song(s) on the record or album, without requiring the user to search for the songs individually.

In one embodiment, the artist-centric application may also use other data when determining whether a recognition event is to occur. For example, along with comparing an identified structural pattern (of the image) with the predefined structural pattern, the application may also use location data (e.g., GPS coordinates) to determine whether there is a recognition event. For instance, if the user captures the image of a poster that showcases a particular artist, while waiting in a queue at that artists concert being held at a particular concert arena, a matching predefined structural pattern may be associated with “behind the scenes” specially licensed content recorded by the artist, at that concert arena, on that particular day. In one embodiment, rather than being a static object link a poster, the matching predefined structural pattern may from other types of memorabilia (e.g., a T-shirt) that may be seen and/or brought to the concert arena.

An application associated with a company (or organization) may present a user with an option to purchase content or products sold by the company. For example, in the case in which the company is a retailer that sells several different types of products, the option to purchase a product from that company may be in response to comparing prices with competitors of that company. For instance, with the (“company-centric”) application 120 open, the user may capture an image of the (e.g., physical) product sold at a competitor's place of business or website, or an advertisement for the product. The pattern recognizer 135 may identify a structural pattern from the image (e.g., the product, the label on the product, or a barcode), and compare the identified structural pattern with predefined structural patterns. In response to a recognition event, the application 120 may present an option to purchase the product or a similar product (e.g., through an in-app purchase). If purchased, in one embodiment, the user may choose whether to be receive the product in the mail or retrieve the product from a “brick-and-mortar” location of the company. This may allow a user to “bargain hunt” for particular products, by viewing competitive pricing (or better offers) provided by the company associated with the application.

In addition to providing users with competitive pricing, the company-centric application may allow users to compare the company associated with the application with its competitors. For example, in the case in which the company is a mobile phone service provider, a user may be presented with a promotional video in addition to or in lieu of an option to purchase content and/or products, in response to comparing the company with its competitors. With the application 120 open, the user may capture an image of an object related to the competitor (e.g., a logo, an advertisement, a promotion, or a product). The pattern recognizer may identify patterns within the image and compare them with predefined structural patterns. Upon finding a matching predefined structural pattern, the application 120 may present content related to the matching pattern, such as a promotional video prepared by the company. In one embodiment, the promotional video may introduce the user to a comparable or similar promotion (or product) to that offered by the competitor. At the end of the video, in one embodiment, the user may be presented with an option to accept the promotion and/or learn more about the promotion (e.g., by navigating the user to the company's website upon receiving a selection of the option).

As previously described, an application associated with a location (e.g., location-centric application) may present a user with an option to purchase content associated with that particular location. The location may be any location, such as a park, an amusement park, or a national monument. In addition, the location may be a specific area within a location (e.g., an amusement park ride within the amusement park. Once the application 120 which is associated with particular ride is launched in the portable device, and while the device is located within the location of the ride, the user may aim the device at a nearby object, e.g., a poster, a character, or a statute. The camera will then capture an image of the object, and similar to the previously described application, the pattern recognizer 135 will compare a structural pattern of the image with predefined structural patterns. Once a match is found, the application 120 may present the user with an option to purchase content associated with the ride. For example, while waiting in a queue to enter the ride, the user may capture an image of a poster. In response to a recognition event, the location-centric application may present the user with an option to purchase content, such as a “behind the scenes” video of the ride, or a game that is related to the ride. In this way, the user may retrieve additional content about the location that may not have been readily available before.

In one embodiment, rather than being associated with a particular person, place, or company, the application may have a broader scope. For example, the application may be associated with a group of things, such as movies or television shows. This may allow the user to use the application 120 to purchase content about any movie (or even the movie itself). For instance, with the application open, the user may capture an image of an object related to a movie (e.g., a movie poster, a movie sleeve, or products made relating to the movie, such as figurines). Upon the occurrence of a recognition event (e.g., an identified pattern of the object matching a predefined pattern), the application may present the user with an option to purchase or rent the movie depicted in the image. In this way, a user may simply point the device towards an image of the movie, capture an image, and automatically be presented with an option to watch the movie.

Since the application 120 may be performing all of the operations described in process 200, any delay associated with accessing an image pattern recognizer that may otherwise be running on a remote server in the Internet is avoided. Moreover, any delay associated with accessing a decision maker as to which audio-visual content and/or product should be presented for a particular recognition event, is also avoided, thereby making the presentation to the user, of the option to purchase the content and/or products, essentially immediately after the user aimed the device a the object.

Some embodiments perform variations of the process 200. For example, the comparison performed at block 220 may be based on additional data. For example, when comparing the identified structural pattern with the predefined structural pattern, the application may also use location data (e.g., GPS) to determine whether there is a match. For instance, if the image is taken at a concert arena (e.g., The Hollywood Bowl), the matching predefined structural pattern may be associated with “behind the scenes” specially licensed content recorded at that concert arena. In other embodiments, the specific operations of the process 200 may not be performed in the exact order shown and described. The specific operations may not be performed in one continuous series of operations, and different specific operations may be performed in different embodiments.

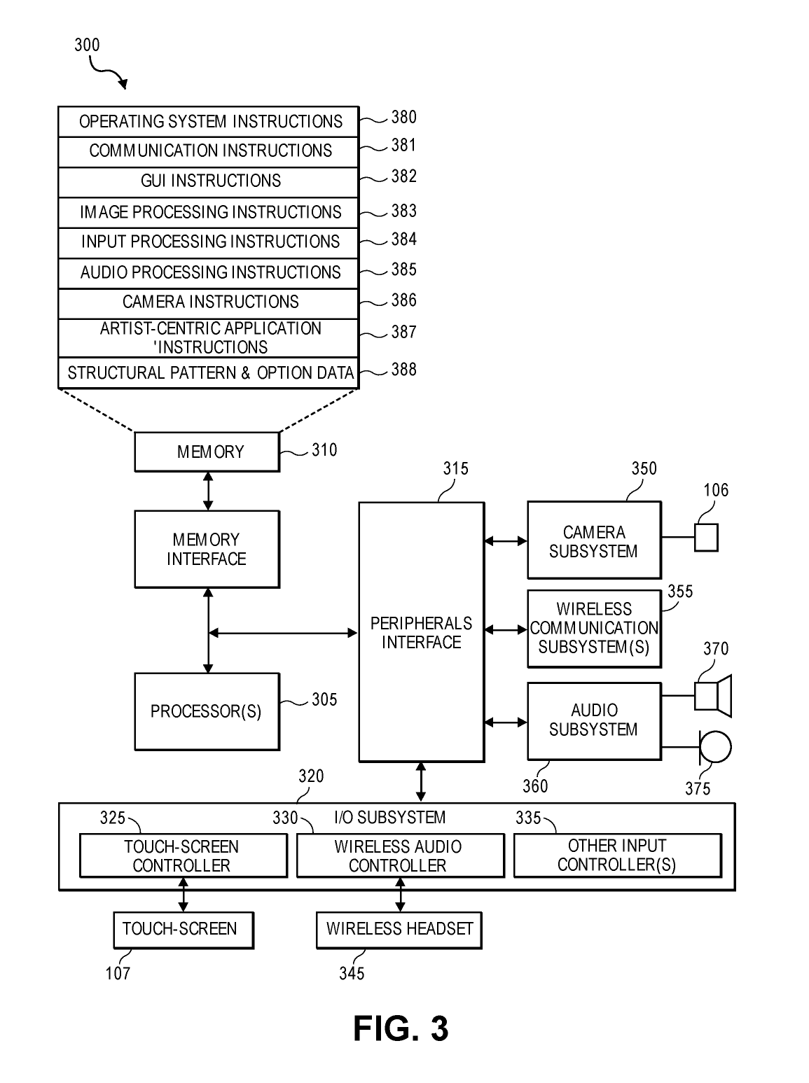

The applications of some embodiments operate on mobile devices, such as smart phones and tablets. FIG. 3 is an example of an architecture 300 of such a mobile computing device. Examples of mobile computing devices include smartphones, tablets, laptops, etc. As shown, the mobile computing device 300 includes one or more processing units (e.g., processors) 305, a memory interface 390 and a peripherals interface 315.

The peripherals interface 315 is coupled to various sensors and subsystems, including a camera subsystem 350, a wireless communication subsystem(s) 355, an audio subsystem 360, an I/O subsystem 320, etc. The peripherals interface 315 enables communication between the processing units 305 and various peripherals.

The camera subsystem 350 is coupled to one or more cameras 106, each with an optical sensors (e.g., a charged coupled device (CCD) optical sensor, a complementary metal-oxide-semiconductor (CMOS) optical sensor, etc.). The camera subsystem 350 coupled with the optical sensors of the cameras 106 facilitates camera functions, such as image and/or video data capturing. The wireless communication subsystem 355 serves to facilitate communication functions. In some embodiments, the wireless communication subsystem 355 includes radio frequency receivers and transmitters, and optical receivers and transmitters (not shown in FIG. 3). These receivers and transmitters of some embodiments are implemented to operate over one or more communication networks such as a GSM network, a Wi-Fi network, a Bluetooth network, etc. The audio subsystem 360 is coupled to a speaker 370 to output audio (e.g., to output sound). Additionally, the audio subsystem 360 is coupled to a microphone 375 to facilitate voice-enabled functions, such as voice recognition (e.g., for searching), digital recording, etc.

The I/O subsystem 320 involves the transfer between input/output peripheral devices, such as a display, a touch screen, etc., and the data bus of the processing units 305 through the peripherals interface 315. The I/O subsystem 320 includes a touch-screen controller 325, a wireless audio controller 330, and other input controllers 335 to facilitate the transfer between input/output peripheral devices and the data bus of the processing units 305. As shown, the touch-screen controller 325 is coupled to a touch-sensitive display screen 107. The touch-screen controller 325 detects contact and movement on the touch screen 107 using any of multiple touch sensitivity technologies. The wireless audio controller 330 is wirelessly coupled to a wireless headset 345 that may be used to receive and transmit audio signals (e.g., during an audio call). The other input controllers 335 are coupled to other input/control devices, such as one or more buttons. Some embodiments include a near-touch sensitive screen and a corresponding controller that can detect near-touch interactions instead of or in addition to touch interactions.

The memory interface 390 is coupled to memory 310. In some embodiments, the memory 310 includes volatile memory (e.g., high-speed random access memory), non-volatile memory (e.g., flash memory), a combination of volatile and non-volatile memory, and/or any other type of memory. As illustrated in FIG. 3, the memory 310 stores an operating system (OS) 380. The OS 380 includes instructions for handling basic system services and for performing hardware dependent tasks.

The memory 310 also includes communication instructions 381 to facilitate communicating with one or more additional devices; graphical user interface (GUI) instructions 382 to facilitate graphic user interface processing; image processing instructions 383 to facilitate image-related processing and functions; input processing instructions 384 to facilitate input-related (e.g., touch input) processes and functions; audio processing instructions 385 to facilitate audio-related processes and functions; camera instructions 386 to facilitate camera-related processes and functions; and artist-centric application instructions 387 to facilitate the presentation of specially licensed content once a pattern-recognition event occurs; and pattern-recognition event data 388 that includes the options to purchase specially licensed content and associated predefined structural patterns. The instructions described above are merely exemplary and the memory 310 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 3 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 3 may be split into two or more integrated circuits.

The following statements of invention may be made.
1. A method performed by a programmed processor in a portable electronic device that is executing a themed application program stored in the device, the method comprising:
analyzing an object that is in an image which has been captured by a digital camera in the device, to detect a structural pattern in the image;
comparing the detected structural pattern with a plurality of predefined structural patterns that are part of the application program and are stored in the device, to identify a matching predefined structural pattern, wherein the application program contains a data structure that associates each predefined structural pattern with an option that describes a piece of content relating to the theme of the application; and
upon identifying a matching predefined structural pattern, presenting, through a touch screen of the portable electronic device, a notification that refers to the option that is associated with the matching predefined structural pattern.
2. The method of statement 1, wherein the theme of the application is one of an artist, a company, a location, or a group of things.
3. The method of statement 2, wherein when the application is themed after an artist, the content comprises specially licensed content that is either textual, graphical, musical, or an audio-visual licensed work of the artist.
4. The method of statement 3, wherein the object captured in the image is from a page of a book that relates to the artist.
5. The method of statement 4, wherein the object is (i) a picture relating to the artist, (ii) text relating to the artist, (iii) or a combination of both.
6. The method of statement 4, wherein the book is either a physical book or a virtual book.
7. The method of statement 2, wherein when the application is themed after a company, the content comprises products sold by the company
8. The method of statement 7, wherein the object captured in the image is from one of an advertisement or promotion of the product by a competitor of the company.
9. The method of statement 2, wherein when the application is themed after a location, the content comprises specially licensed content that is either musical, audio-visual, or an interactive licensed work related to the location.
10. The method of statement 9, wherein the object in the image is captured at a near the location in which the application is themed after.
11. The method of statement 1, wherein the option comprises a textual description of the content, and an identifier or code that references the content which is stored in a remote server.
12. The method of statement 1 wherein in response to receiving a selection in the notification, through the touchscreen:
   sending a message to a remote server to charge an account of a user of the device a purchase price, listed the description of the option; and receiving the specially licensed content of the artist and then presenting the content relating to the theme in the device.

As previously explained, an embodiment of the invention may be a non-transitory machine-readable medium (such as microelectronic memory) having stored thereon instructions, which program one or more data processing components (generically referred to here as a “processor”) to perform the operations described above including capturing images, analyzing objects to identify structural patterns, comparing identified structural patterns with predefined structural patterns, presenting an option to purchase content when a matching predefined pattern is found, and retrieving purchased specially licensed content. In other embodiments, some of these operations might be performed by specific hardware components that contain hardwired logic. Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. A method performed by a programmed processor in a portable electronic device that is executing an artist-centric application program stored in the device, the method comprising:
analyzing an object that is in an image which has been captured by a digital camera in the device, to detect a structural pattern in the image;
comparing the detected structural pattern with a plurality of predefined structural patterns that are part of the application program and are stored in the device, to identify a matching predefined structural pattern, wherein the application program contains a data structure that associates each predefined structural pattern with an option that describes a piece of specially licensed content of an artist; and
upon identifying a matching predefined structural pattern, presenting, through a touch screen of the portable electronic device, a notification that refers to the option that is associated with the matching predefined structural pattern.

2. The method of claim 1, wherein the specially licensed content comprises textual, graphical, musical, or an audio-visual licensed work of the artist.

3. The method of claim 1, wherein the object captured in the image is from a page of a book that relates to the artist.

4. The method of claim 3, wherein the object is (i) a picture relating to the artist, (ii) text relating to the artist, (iii) or a combination of both.

5. The method of claim 3, wherein the book is either a physical book or a virtual book.

6. The method of claim 1, wherein the option comprises a textual description of the specially licensed content, and an identifier or code that references the specially licensed content which is stored in a remote server.

7. The method of claim 1 wherein in response to receiving a selection in the notification, through the touchscreen:
sending a message to a remote server to charge an account of a user of the device a purchase price, listed the description of the option; and
receiving the specially licensed content of the artist and then presenting the specially licensed content of the artist in the device.

8. A portable electronic device comprising
a processor and
memory having stored therein instructions that when executed by the processor:
analyze an object that is in an image which has been captured by a digital camera in the device, to detect a structural pattern in the image; and
compare the detected structural pattern with a plurality of predefined structural patterns that are stored in the device, to identify a matching predefined structural pattern, wherein the memory contains a data structure that associates each predefined structural pattern with an option that describes a piece of specially licensed content of an artist; and
upon identifying a matching predefined structural pattern, present, through a touch screen of the portable electronic device, a notification that refers to the option that is associated with the matching predefined structural pattern.

9. The device of claim 8, wherein the specially licensed content comprises textual, graphical, musical, or an audio-visual licensed work of the artist.

10. The device of claim 8, wherein the object captured in the image is from a page of a book that relates to the artist.

11. The device of claim 10 wherein the object is (i) a picture relating to the artist, (ii) text relating to the artist, (iii) or a combination of both.

12. The device of claim 10, wherein the book is either a physical book or a virtual book.

13. The device of claim 8, wherein the option comprises a textual description of the specially licensed content, and an identifier or code that references the specially licensed content which is stored in a remote server.

14. The device of claim 8 wherein in response to receiving a selection in the notification, through the touchscreen the processor
sends a message to a remote server to charge an account of a user of the device a purchase price, listed the description of the option; and
receives the specially licensed content of the artist and then presents the specially licensed content of the artist in the device.

15. A method performed by a programmed processor in a portable electronic device that is executing a themed application program stored in the device, the method comprising:
analyzing an object that is in an image which has been captured by a digital camera in the device, to detect a structural pattern in the image;
comparing the detected structural pattern with a plurality of predefined structural patterns that are part of the application program and are stored in the device, to identify a matching predefined structural pattern, wherein the application program contains a data structure that associates each predefined structural pattern with an option that describes a piece of content relating to the theme of the application; and
upon identifying a matching predefined structural pattern, presenting, through a touch screen of the portable electronic device, a notification that refers to the option that is associated with the matching predefined structural pattern.

16. The method of claim 15 wherein the theme of the application is one of an artist, a company, a location, or a group of things.

17. The method of claim 16 wherein the application is themed after an artist, and the content comprises specially licensed content that is either textual, graphical, musical, or an audio-visual licensed work of the artist.

18. The method of claim 16 wherein the application is themed after a company, and the content comprises products sold by the company.

19. The method of claim 18 wherein the object captured in the image is from one of an advertisement or promotion of the product by a competitor of the company.
